(19) United States
(12) Patent Application Publication
(10) Pub. No.: US 2025/0148003 A1
(43) Pub. Date: May 8, 2025

(54) System and Method for Modifying Search Metrics Based on Features of Interest Determined from Interactions with Images

(71) Applicant: Shopify Inc., Ottawa (CA)

(72) Inventor: Rohit JACOB, San Francisco, CA (US)

(73) Assignee: Shopify Inc., Ottawa (CA)

(21) Appl. No.: 18/502,375

(22) Filed: Nov. 6, 2023

(51) Int. Cl. G06F 16/532; G06F 16/583; G06F 40/40; G06T 11/60; G06V 10/44; G06V 10/74; G06V 10/774; G06V 10/94

(52) U.S. Cl. CPC G06F 16/532; G06F 16/583; G06F 40/40; G06T 11/60; G06V 10/44; G06V 10/74; G06V 10/774; G06V 10/945

(57) ABSTRACT

A system and method are provided for modifying search metrics based on features of interest determined from interactions with images. The method includes determining an input comprising at least one feature of interest, the at least one feature of interest determined from at least one interaction with a first image; and using the input in an image search by modifying a search metric to bias the image search towards locating one or more second images based on the at least one feature of interest.

### TECHNICAL FIELD

The following relates generally to modifying search metrics and, in particular, to modifying such search metrics based on features of interest determined from interactions with images.

### BACKGROUND

Scenarios may arise where a user is interested in searching for something they have in mind, such as a piece of clothing. In performing their search, the user may have identified an image of something that is “almost” what they want. For example, they may like a shirt that comes in a V-neck but would prefer to have the same shirt but in a crew neck.

### BRIEF DESCRIPTION OF THE DRAWINGS

Embodiments will now be described with reference to the appended drawings wherein:

FIG. 1A is a block diagram of a simplified convolutional neural network, which may be used in examples of the present disclosure.

FIG. 1B is a block diagram of a simplified transformer neural network, which may be used in examples of the present disclosure.

FIG. 2 is a block diagram of an example computing system, which may be used to implement examples of the present disclosure.

FIG. 3a is an example of a computing environment in which a boosted search module is provided with or accessible to an application.

FIG. 3b is an example of a configuration for the boosted search module shown in FIG. 3a.

FIG. 4 is an example of a computing device having an application and search function configured to utilize a boosted search engine.

FIG. 5. is a flow chart illustrating example operations for modifying a search metric to bias an image search towards locating one or more second images based on one or more features of interest.

FIGS. 6a, 6b, 6c, and 6d show example image editing interactions.

FIGS. 7a and 7b show an example of an image zoom interaction.

FIGS. 8a and 8b show an example of another image editing interaction.

FIG. 9 is a flow chart illustrating example operations for adjusting a subsequent search based on interactions with an image from a previous search.

FIG. 10 is a flow chart illustrating example operations for determining search metrics to boost a subsequent search.

FIGS. 11a, 11b, 11c, and 11d show an example of a subsequent search boosted by interactions with an image from a previous search.

FIG. 12 is a block diagram illustrating an example of a configuration for an e-commerce platform.

FIG. 13 shows an example of a user interface for interacting with the e-commerce platform shown in FIG. 12.

FIG. 14 is a block diagram illustrating an example of the e-commerce platform of FIG. 12 with an integrated boosted search module.

### DETAILED DESCRIPTION

A user may desire to provide an input to a computer program they are using (e.g., a search engine or merchant website) with a desired modification to an image found or provided to them, which is almost what they want. In this way, the user may continue their search for an ideal or preferred product.

The following system and method may use an input indicative of something (e.g., one or more features) in one image of an item that the user is most interested in (or would change), to boost or otherwise enhance, revise, or refine a subsequent search for images containing the item(s) or feature(s) of interest. The search query (e.g., keywords chosen) may be modified or augmented based on the items or features of interest. Additionally or alternatively, the results returned by the subsequent search may be reordered or filtered by selecting items based on a higher weight attributed to the feature(s) associated with the input, or by otherwise structuring the subsequent search to focus on certain attributes or features of objects of interest in the search.

In one aspect, there is provided a computer-implemented method, comprising: determining an input comprising at least one feature of interest, the at least one feature of interest determined from at least one interaction with a first image; and using the input in an image search by modifying a search metric to bias the image search towards locating one or more second images based on the at least one feature of interest.

In certain example embodiments, the at least one feature of interest may be determined from the at least one interaction with the first image by associating the at least one interaction with one or more portions of the first image.

In certain example embodiments, the at least one feature of interest may be determined by applying a feature extraction technique to at least the one or more portions of the first image.

In certain example embodiments, the one or more portions of the first image may comprise an edited portion of the first image.

In certain example embodiments, the method may further include providing an image editing tool; obtaining the at least one interaction with the first image based on edits to the first image made using the editing tool; associating the edits with the one or more portions of the first image; and applying the feature extraction technique to identify the at least one feature of interest according to what was edited using the editing tool.

In certain example embodiments, the feature extraction technique applies a SIFT algorithm.

In certain example embodiments, the search metric comprises a feature weight.

In certain example embodiments, the at least one feature of interest may be determined by: comparing an original first image to a modified first image to determine one or more changes; and associating the one or more changes with the at least one feature of interest.

In certain example embodiments, the comparing may be performed by prompting a LLM to describe what has changed between the original first image and the modified first image.

In certain example embodiments, the one or more changes may comprise an edited portion of the original first image.

In certain example embodiments, the method may further include: providing an image editing tool; obtaining the at least one interaction with the first image based on edits to the original first image made using the editing tool to generate the modified first image; associating the edits with one or more portions of the original first image; and applying the feature extraction technique to identify the at least one feature of interest according to what was edited using the editing tool.

In certain example embodiments, the method may further include training at least one model associated with one or more of: i) the at least one interaction, ii) associating the at least one interaction with one or more portions of the first image, or iii) the image search; based on an item category associated with the at least one feature of interest.

In certain example embodiments, the item category may include a product category.

In certain example embodiments, the at least one interaction may include the selection of a feature, zooming of a feature, annotating a feature, or identifying a feature using text, voice or eye gaze.

In certain example embodiments, the first image may be obtained from a first search and the image search corresponds to a subsequent search.

In another aspect, there is provided a system comprising at least one processor; and at least one memory. The at least one memory includes processor executable instructions that, when executed by the at least one processor, cause the system to: determine an input comprising at least one feature of interest, the at least one feature of interest determined from at least one interaction with a first image; and use the input in an image search by modifying a search metric to bias the image search towards locating one or more second images based on the at least one feature of interest.

In certain example embodiments, the at least one feature of interest may be determined from the at least one interaction with the first image by associating the at least one interaction with one or more portions of the first image.

In certain example embodiments, the at least one feature of interest may be determined by applying a feature extraction technique to at least the one or more portions of the first image.

In certain example embodiments, the at least one feature of interest may be determined by: comparing an original first image to a modified first image to determine one or more changes; and associating the one or more changes with the at least one feature of interest.

In another aspect, there is provided a computer-readable medium comprising processor executable instructions that, when executed by a processor, cause the processor to: determine an input comprising at least one feature of interest, the at least one feature of interest determined from at least one interaction with a first image; and use the input in an image search by modifying a search metric to bias the image search towards locating one or more second images based on the at least one feature of interest.

The input may be generated based on interactions by the user. These interactions may be provided by the user in numerous ways. For example, an image editing tool such as the DragGAN AI™ tool may be presented to the user to allow them to edit images, specifically, by dragging a portion of the image to another point on the image (e.g., making the hem of a skirt or sleeves of a shirt longer). Other changes may include, for example, recoloring and/or brush/painting using other types of image editing tools to alter colors and shades. In this way, the user may apply various changes or otherwise generally “interact” with an image in a way that suggests, applies, highlights or in some way infers what they would make a change to some object or feature in the image. In the above example, a user may find a V-neck shirt they like (e.g., in terms of color, style, brand, etc.) but prefer something like that shirt in a crew neck style. This can be captured when the user edits the image to drag the collar portion of the shirt upwards to convert the V-neck to a crew neck.

Other interaction examples include feature selection (e.g., tap, click, bounding box), text entry (e.g., textually explaining a change), voice input (e.g., verbally explaining a change), eye tracking (e.g., dwelling or focusing on a feature), zooming (e.g., enlarging and centering a feature in a field of view), or other inputs providing emphasis such as highlighting or annotating, etc. Additionally or alternatively, feature removal or deletion tools, such as an eraser tool may be provided to the user to edit an image in a way that suggests certain features are disliked and should be avoided, boosted downwardly, or penalized in subsequent search results.

Features associated with the interactions may be detected by the process using any suitable technique, including a Scale Invariant Feature Transform (SIFT) algorithm to extract features that are determined to have been selected, edited, etc. Other algorithms such as LLaVA (Large Language and Vision Assistant) may utilize a large language model (LLM) by inputting before and after images (associated with the input) with a prompt to the LLM to describe what changed. These changes may then be used to generate the input to boost the subsequent search.

The input used to boost the search is therefore based on a determination of features of interest that should be more prominent in the subsequent searches. The input may be generated in part using metadata either gathered during the user interactions and/or which already exist and are stored in association with the image. For example, pixel locations associated with interactions by the user may be correlated with existing feature tags in the image to provide additional descriptive detail to be used in the subsequent search.

The input may be used to add, modify, remove, create or change one or more search metrics used in a subsequent search. For example, a search string for a “plain t-shirt” may be modified in the above example to more specifically search using the keyword “crew neck” such that the search string includes a combination of the terms “plain”, “t-shirt”, and “crew neck”. The search query may be modified according to the structure used by the searching tool. For example, if weights are applied to search terms such that terms with higher weights feature more prominently in the search results, such weights may be adjusted for features associated with the input generated based on the interactions with the initial image. Similarly, prompts used to query an LLM used in conducting the subsequent search may be generated with prominence given to features of interest.

In this way, a search may be “boosted” to focus on the features that the user has identified as being of interest or to avoid features that the user has identified as being of disinterest. The boosted search may also be informed by intent determined based on the user interactions that are used to generate the input. For example, the user may edit an image to indicate what they like as well as what they do not like. In the above example, the user's intent is to find a shirt that is almost exactly like the shirt they edited, but with a crew neck. The input could, viewed another way, be considered a search for images that do not include a V-neck. As such, what the user likes, dislikes, would change, and the nature of that change may be used to formulate the input.

The system and method described herein may therefore determine an input used to boost a search based at least in part on features of interest identified through interactions by the user, with an image, which are detected by a boosted search module. Various types of interactions with the image are possible and various feature extraction techniques may be used to generate the input.

### Neural Networks and Machine Learning

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

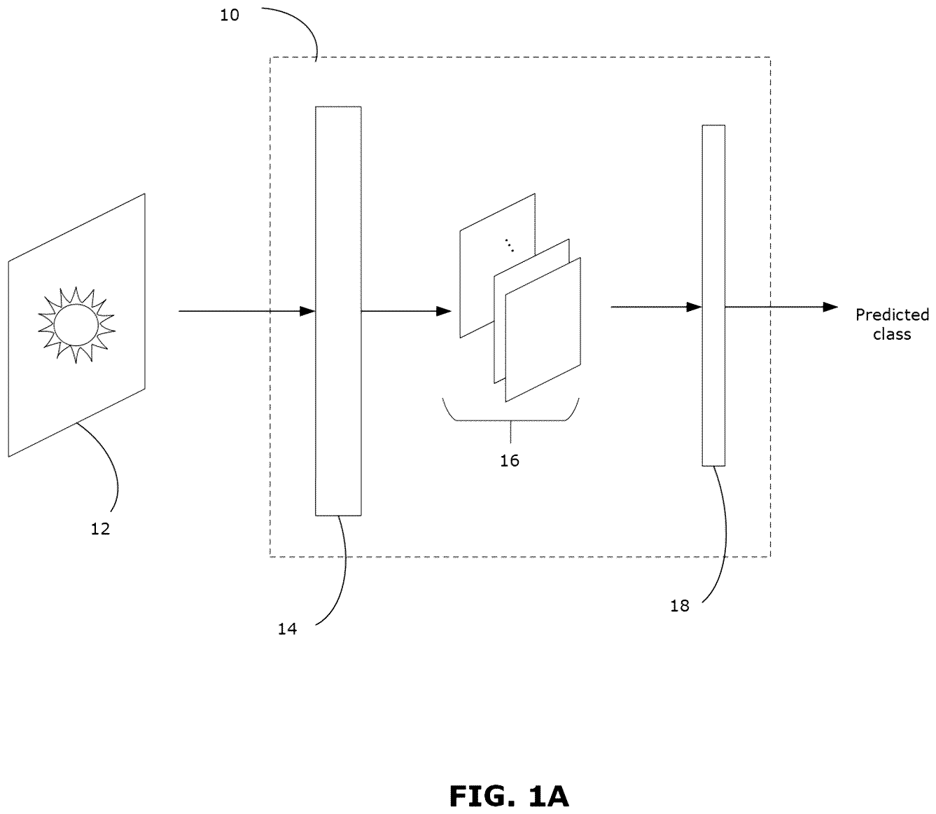

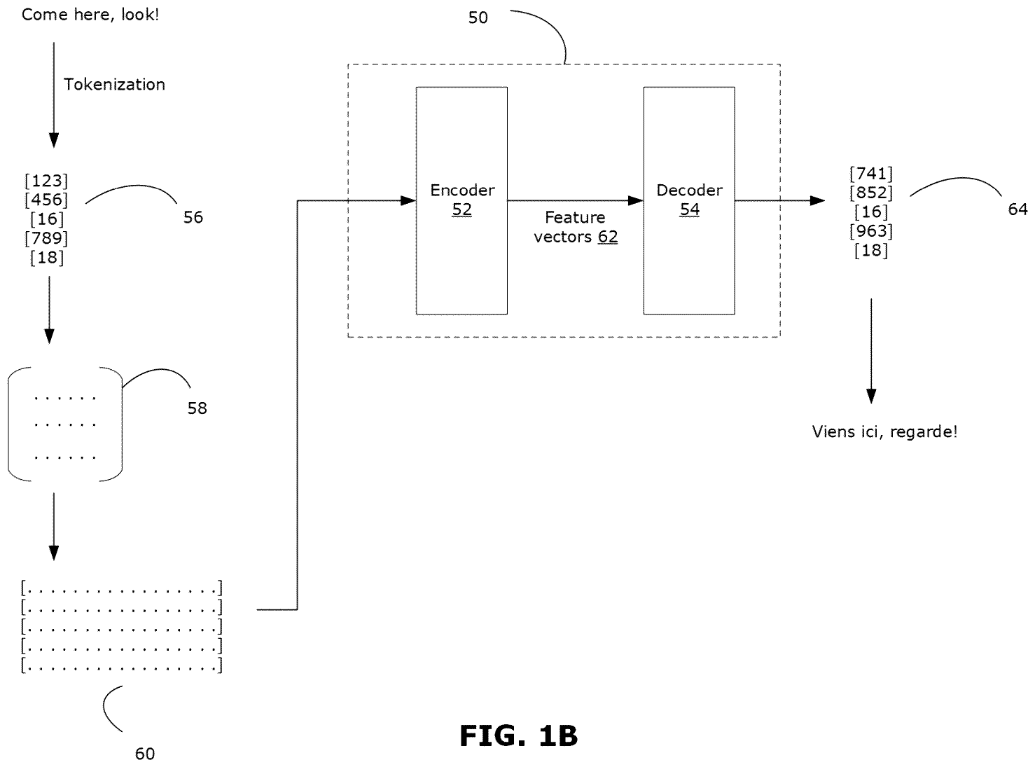

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a LLM may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

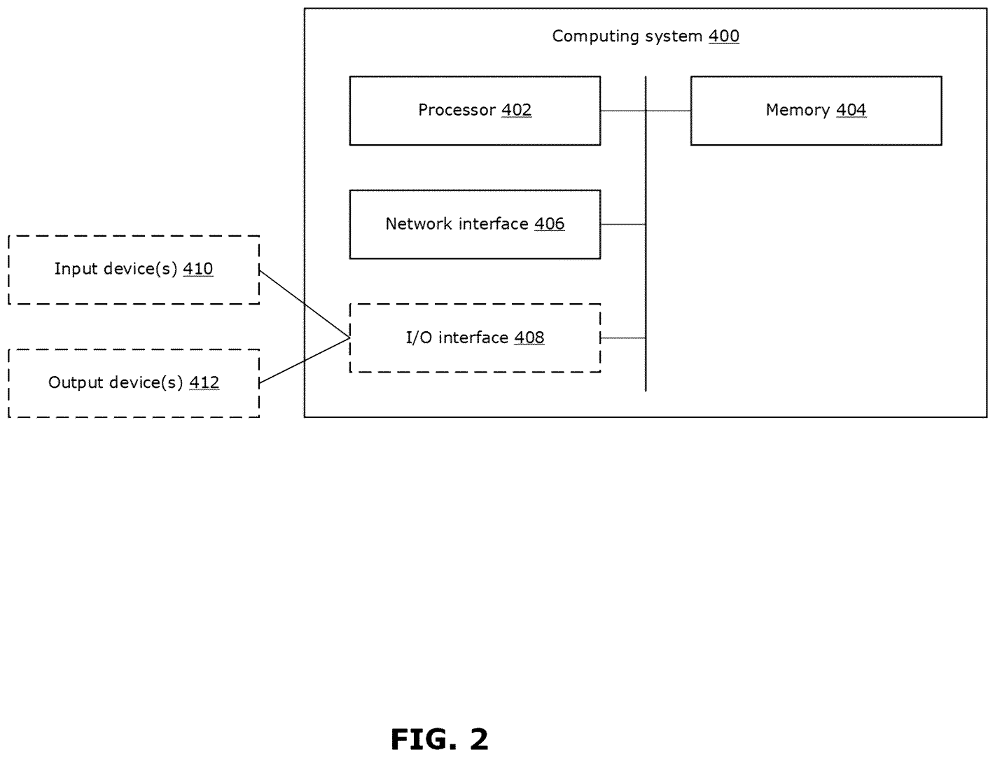

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Modifying Search Metrics Based on Features of Interest Determined from Interactions with Images

To determine and use an input indicative of something in one image (e.g., one or more features) of an item that the user is most interested in (or would change), to boost or otherwise enhance, revise, or refine a subsequent search for images containing the item(s) or feature(s) of interest; the following enables users to interact with the image and determines features of interest from interactions between the user and the image. Search metrics for the subsequent search may be modified based on the features of interest to boost the subsequent search based on the interactions.

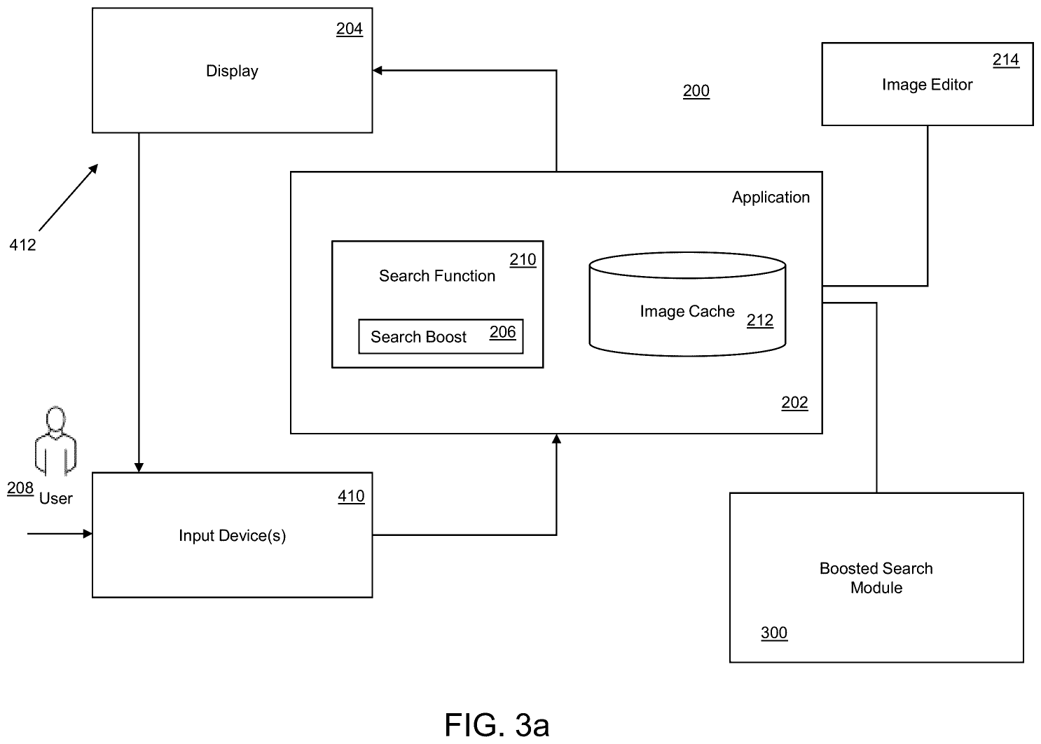

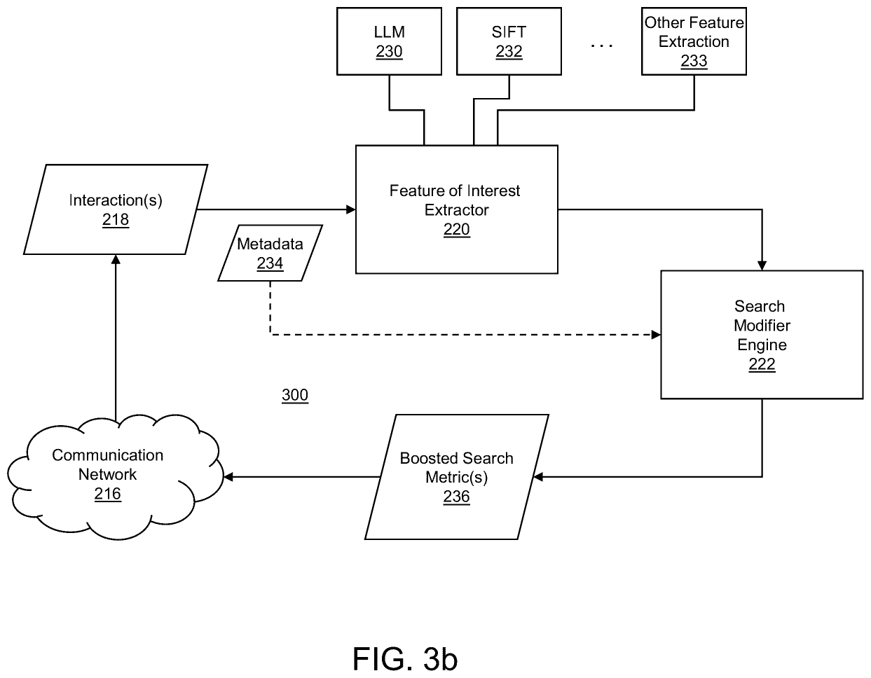

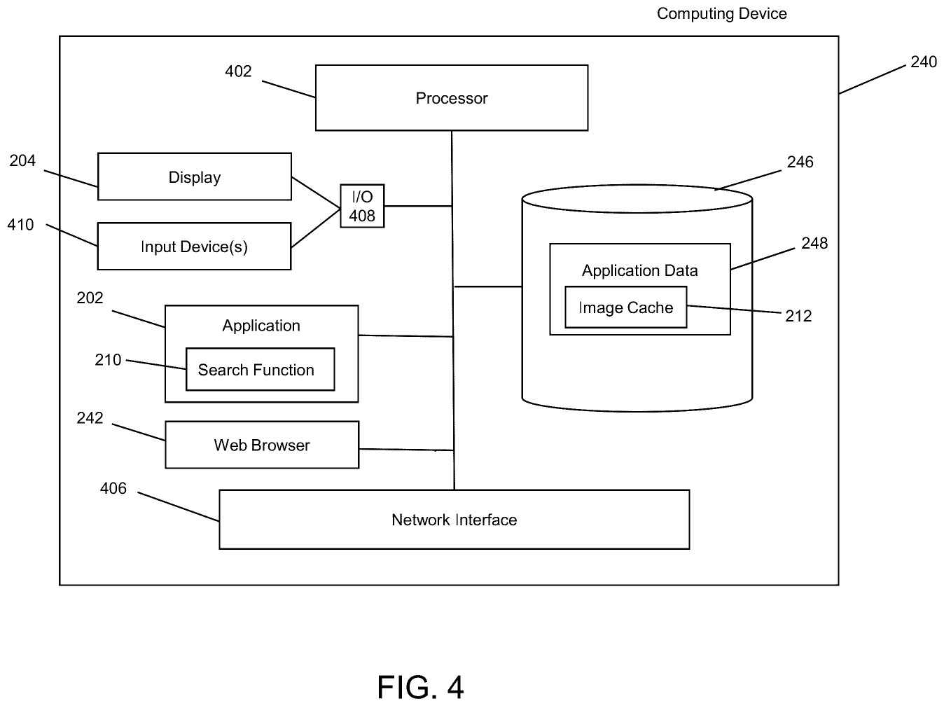

FIG. 3a illustrates an example of a computing environment 200 in which an application 202 is provided by or with one or more computing devices 240 (see FIG. 4) or computing systems 400 (see FIG. 2 described above). Such computing systems 400 or computing devices 240 can include, but are not limited to, a mobile phone, a personal computer, a laptop computer, a tablet computer, a notebook computer, a hand-held computer, a personal digital assistant, a portable navigation device, a wearable device, a gaming device, an embedded device, a smart phone, a virtual reality device, an augmented reality device, etc. The application 202 includes a search function 210 to enable a user 208 to interact with the application 202 to search for a desired object such as a product. In examples described herein, the search function 210 may, at least in part, return images of such objects to enable a user to view and visualize the object. The application 202 can take the form of a desktop-type application, a mobile-type application (also referred to as an “app”), an embedded application in customized computing systems, or an instance or page contained and provided within a web/Internet browser 250 (e.g., see FIG. 4), to name a few. The search function 210, while shown as part of the application 202, can instead be provided by a separate computing device 240 or computing system 400 used to run the application 202. As such, the configuration shown in FIG. 3a is illustrative and other computing device/system configurations are possible as shown by way of example in FIGS. 2, 3b and 4.

For example, the computing environment 200 shown in FIG. 3a can represent a single device such as a portable electronic device or the integration/cooperation of multiple electronic devices such as a client device and server device or a client device and a remote or offsite storage or processing entity or service. That is, the computing environment 200 can be implemented using any one or more electronic devices including standalone devices and those connected to offsite storage and processing operations (e.g., via cloud-based computing storage and processing facilities). For example, the search function 210 may be provided by an electronic device while an image cache 212 used by such a search function 210 can, at least in part, be stored and accessed from an external memory or application, including a cloud-based service or application 202.

The application 202 and search function 210 are coupled to a display 204 to render and present/display user interface (UI) elements, UI components, and UI controls utilized by a UI rendered by application 202 (e.g., via or including the search function 210), on the display 204. While examples referred to herein may refer to a single display 204 for ease of illustration, the principles discussed herein can also be applied to multiple displays 204, e.g., to view portions of UIs rendered by or with the application 202 on separate side-by-side screens. That is, any reference to a display 204 can include any one or more displays 204 or screens providing similar visual functions. The application 202 receives one or more inputs from one or more input devices 410, which can include or incorporate inputs made via the display 204 as illustrated in FIG. 3a as well as any other available input to the computing environment 200 (e.g., via the I/O interface 408 shown in FIG. 2), such as haptic or touch gestures, voice commands, eye tracking, biometrics, keyboard or button presses, etc. Such inputs may be applied by a user 208 interacting with the computing environment 200, e.g., by operating an electronic device having the display 204 and at least an interface to one or more input devices 410.

The application 202 or a computing device 240 within the computing environment 200 can include or have access to application data 248 (see FIG. 4). The application data 248 can include data used by the application 202 to perform operations provided by the features associated with the application 202, including data used in rendering UIs such as a UI that includes the search function 210. The application data 248 may include an image cache 212, which provides a storage allocation for images interacted with by the user, e.g., images returned by the search function 210, presented to the user, and interacted with by the user, e.g., using an image editor 214 (seen in FIG. 3a) as discussed below, and for other data associated with such objects that may be used by the application 202, e.g., using the search function 210, in providing editing or modification capabilities to the user 208 via an editing or interactivity UI. The search function 210 may be the primary function of the application 202 (e.g., a search engine) or may be a plug-in, tool or other feature provided in or accessible to the application 202. The search function 210 may provide an application programming interface (API) to an external module or engine such as a chat service that utilizes an LLM (e.g., ChatGPT) to utilize external language models to conduct a search for the application 202.

The application 202 may include, or as shown in the example configuration of FIG. 3a, have access to, a boosted search module 300. The boosted search module 300 may be used by a search boost feature 206 of the search function 210 to enable users to interact with an image (e.g., from a first set of search results), determine features of interest from such interactions, and modify a subsequent search for other images to “boost” the subsequent search based on the features of interest. The interactions with the image may be provided by the user via various tools. For example, the user may zoom, highlight, or select/tap a feature thus indicating an interest in that feature. Other interactions may include edits or modifications to the image, such as adding or removing a feature, or changing a feature. The interactions may, additionally or alternatively, include indirect interactions such as text, voice or gestures in reference to features of the image, e.g., by instructing the search function 210 what the user likes or dislikes in the image. In the example shown in FIG. 3a, an image editor 214 is shown, which is one example of a tool that may be provided to the user to enable them to interact with an image. It will be appreciated that the image being interacted with may originate from any source or workflow such as a selection from an electronic catalogue or website and need not originate from an initial search.

FIG. 3b illustrates an example of a configuration for implementing a workflow executed by the boosted search module 300. The boosted search module 300 in this example is coupled to a communication network 216, e.g., to communicate with a computing device 240 or computing system 400 in the computing environment 200. Such communication network(s) 216 may include a telephone network, cellular, and/or data communication network to connect different types of client- and/or server-type devices. For example, the communication network 216 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet). It can be appreciated that in configurations wherein the boosted search module 300 is integral to the application 202 and/or provided on the same device within the computing environment 200, the communication network 216 may represent or be replaced by a communication bus or logical/programmatical connection between the boosted search module 300 and the application 202.

The boosted search module 300 may receive data and information collectively referred to herein as one or more interactions 218 via the communication network 216 and generate and provide an output such as one or more boosted search metrics 236, e.g., to/from the application 202. The one or more interactions 218 may be provided to a feature of interest extractor 220. The feature of interest extractor 220 determines from, for example, metadata 234 associated with the interactions 218 (or from the interactions 218 directly), one or more features of interest from the image that the user was able to interact with. For example, the user may be presented with an image to view, enlarge, edit, or provide commentary on; or to indicate what feature or features of an object they like, dislike, would change, would add, would remove, etc. The feature of interest extractor 220 may use metadata 234 associated with or included in the interactions 218 (or from the interactions 218 directly) to determine what, if any, features of interest were interacted with by the user.

The feature of interest extractor 220 may determine a feature of interest using various processes and techniques. For example, a computer vision algorithm such as SIFT 232 may be used to detect features associated with pixels or regions of an image that were selected, zoomed/enlarged, or edited. An edited image may, additionally or alternatively, be compared with the original image to determine what has changed, thus indicating a feature of interest for boosting up or down in a subsequent search. For example, algorithms such as LLaVA may utilize a LLM 230 by inputting before and after images with a prompt to the LLM 230 to describe what changed. Other computer vision-related feature extraction techniques 233 accessible to the feature of interest extractor 220 may be used. For example, any suitable low-level image processing operation that detects features in pixels or groups of pixels and maps those features to pixels that have been interacted with (e.g., edited) by the user may be used. This may include processing operations that include, without limitation, edge detection, corner detection, blob detection, Hough transforms, structure tensors, invariant feature detection, and other feature description algorithms similar to SIFT.

In other example embodiments, the metadata 234 may include feature tags or labels from information already associated with features in an image. For example, an image of a product may include a number of tagged features already present in image metadata that may be extracted and mapped or otherwise correlated to an interaction. The metadata 234 may, additionally or alternatively, include descriptors provided directly by the user. For example, the search boost feature 206 may prompt the user to describe what changes they would make, if any, to the product shown in an image and have the associated input parsed by the feature of interest extractor 220 or a search modifier engine 222 directly as shown in dashed lines in FIG. 3b.

It can be appreciated that the feature of interest extractor 220 and search modifier engine 222 are shown as separate modules for ease of illustration and may instead be provided using a single module. The search modifier engine 222 may be used to translate the features of interest and any associated metadata 234 to one or more boosted search metrics 236. The boosted search metric(s) 236 may be generated and returned to the search function 210 by the boosted search module 300, e.g., via the communication network 216, to enable the application 202 to provide an enhanced similarity boost 206 operation within the search function 210. As such, the search boost feature 206 may be provided as a plug-in to a standard search function 210 or may be integrated as an option in other examples. The image editor 214 is shown for illustrative purposes. Multiple image editors 214 may be made available to the search function 210 and/or search boost feature 206 to allow images stored in the image cache 212 to be interacted with, in this example, to edit the contents of an image. In other example embodiments, additionally or alternatively, other image manipulation tools such as paint, erasure, annotation, highlighting, zooming, etc. may be provided either by external entities as illustrated in FIG. 3a, or via the application 202 or another application within the same computing environment 200.

Returning to FIG. 3b, the search modifier engine 222 may generate boosted search metrics 236 that are adapted to the format or syntax utilized by the search function 210 or application 202. For example, the boosted search metrics 236 may include a more detailed search string that includes additional keywords to narrow in on features of interest of an object from the image. Such keywords may be used to prompt external searching resources such as LLMs 230. While the LLM 230 in FIG. 3b is shown as coupled to the feature of interest extractor 220 the same or different LLMs 230 may be accessible to the search function 210 to utilize language models in conducting at least the subsequent search. In other examples, the search string may be unchanged, but weights are applied to features that can be identified in search result entries such that the search results in a subsequent search are reordered with features of interest being boosted accordingly. The boosted search metrics 236 may therefore correspond to search query metrics or search results that order and/or filter metrics in certain example embodiments.

The metadata 234 may identify one or more embeddings from the image that may be used by the feature of interest extractor 220 to determine what the feature of interest is or relates to or to describe what in the image is liked or disliked by the user. That is, the interactions 218 may intersect with embeddings from the image that inform the feature of interest extractor 220 and search modifier engine 222 regarding how to adjust the boosted search metrics 236 to narrow in on the features of interest to enhance a subsequent search in order to find something that is closer to being “exactly” what the user desires. By identifying the features, the feature of interest extractor 220 and search modifier engine 222 may enhance the description of the desired object in the subsequent search. For example, a product catalogue of items may have an associated database of object images that is used to provide product details in a product page UI. The product catalogue may include products that have embeddings that may be used by the search function 210 to match, associate, correlate or otherwise find similarity with the embeddings associated with the interactions 218 in a subsequent search.

The feature of interest extractor 220 may further include a ML training module or provide data to an external training module to train a model associated with operations described herein. For example, the model may be trained on the interaction(s). The model may, additionally or alternatively, be trained based on associations between the at least one interaction and one or more portions of the first image. Similarly, the model may be trained on the image search and subsequent engagement by the user. This may include training a model based on an item category associated with the at least one feature of interest.

While the boosted search module 300 is shown as being a separate tool accessed by the application 202 over communication network 216 this is only one possible configuration. That is, the boosted search module 300 may, additionally or alternatively, be integral to the application 202 or may reside on the same computing device 240 or computing system 400 as the application 202 in other example configurations. Moreover, the communication network 216 shown in FIG. 3b may, additionally or alternatively, be internal to the computing environment 200. In the configuration shown in FIG. 3b, a cloud-based or otherwise external service may be provided to the application 202 and other applications (not shown) in a centralized and distributed manner. In this way, other types of applications 202 or services may leverage the boosted search module 300. The search function 210 is only one example of an input mechanism that may be used to obtain the interaction(s) 218. For example, the interaction(s) 218 may be determined from browsing data or other input signals generated by or for the user 208 when interacting with the computing environment 200 for any purpose for which finding an object that is a modified version of something seen in an image may be desirable. As indicated above, the principles discussed herein may be used in various settings such as for services (e.g., travel, media), design (e.g., technical, fashion, architectural) and other user experiences that involve boosting subsequent searches based on interactions with a first or original image.

FIG. 4 shows an example of a computing device 240 implementing an example embodiment of the computing environment 200 shown in FIG. 3a in which an application 202 and search function 210 may be used. In this example, the computing device 300 includes one or more processors 402 (e.g., a microprocessor, microcontroller, embedded processor, digital signal processor (DSP), central processing unit (CPU), media processor, graphics processing unit (GPU) or other hardware-based processing units) and one or more network interfaces 406 (e.g., a wired or wireless transceiver device connectable to a network via a communication connection), as illustrated in FIG. 2. Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc. The computing device 240 also includes a data store 246, the application 202 (which in this example includes a search function 210) and/or a web browser 250. The data store 306 may represent a database or library or other computer-readable medium configured to store data and permit retrieval of such data. The data store 246 may be read-only or may permit modifications to the data. The data store 246 may also store both read-only and write accessible data in the same memory allocation. In this example, the data store 246 stores application data 248 for the application 202, which may include the image cache 212. The image cache 212 may enable the application 202 to temporarily store images for use during a session or for any suitable period of time requested by the application 202.

While not delineated in FIG. 4, the computing device 240 includes at least one memory 404 (see also FIG. 2) or memory device that can include a tangible and non-transitory computer-readable medium having stored therein computer programs, sets of instructions, code, or data to be executed by processor(s) 402. The processor(s) 402 and network interface(s) 406 are connected to each other via a data bus or other communication backbone to enable components of the computing device 240 to operate together as described herein. FIG. 4 illustrates examples of modules and applications stored in memory 404 on the computing device 240 and operated by the processor(s) 402. It can be appreciated that any of the modules and applications shown in FIG. 4 may be hosted externally and be available to the computing device 240, e.g., via a network interface 406. The data store 246 in this example stores, among other things, the application data 248 that can be accessed and utilized by the application 202. The computing device 240 also includes the display 204 and one or more input device(s) 410 (see also FIG. 2) that may be utilized as described above. The web browser 250 is shown by way of example to illustrate that the application 202, or an application that is similarly configured, may be accessed by a user of the computing device 240 via a network 216 accessible via the network interface 406. That is, an application 202 and search function 210 may also be accessed and utilized by the computing device 240 from a server or other remote source and need not be a locally running application 202.

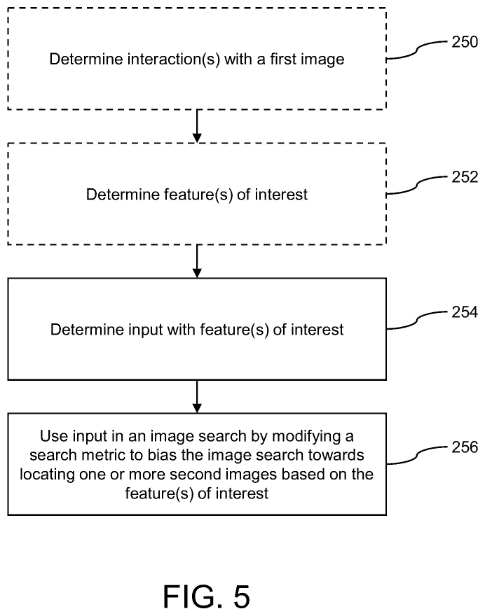

Referring now to FIG. 5, a flow chart is provided illustrating example operations for modifying search metrics to generate the boosted search metrics 236, based on features of interest determined from interactions with images. The operations shown in FIG. 5 may be implemented by an electronic device (e.g., computing device 240 shown in FIG. 4 or computing system 400 shown in FIG. 2), a server, or other computing device 240 in the computing environment 200. In FIG. 5, blocks 250 and 252 are shown in dashed lines to indicate that these operations may be optional or otherwise performed by another entity or provided in other data and information rather than being performed as part of the illustrated method.

At block 250, one or more interactions 218 with an image are determined. The interaction(s) 218 may be determined by the search boost feature 206 of the search function 210 and/or a tool being provided to, and used by, a user, such as the image editor 214. For example, the search boost feature 206 may be initiated within the search function 210 to enable a user to modify an object in an image that was returned by the search function 210. The search boost feature 206 may then launch the image editor 214 to enable the user to edit the image as illustrated in various examples below. In other examples, as discussed above, the search boost feature 206 may provide access to various other tools, including, without limitation, zoom, annotate, color, highlight, select, tap, etc.

At block 252, the interaction(s) 218 determined at block 250 may be used to determine one more features of interest. As discussed above, the feature of interest extractor 220 may use various image processing techniques to identify a feature or object in the image that was interacted with. For example, a portion of an object edited using the image editor 214 may be identified using SIFT 232 or by using a LLM 230 to determine what has changed between the before and after images. Pixels selected or otherwise interacted with by the user may, additionally or alternatively, be mapped to tags, labels or other embeddings in the image to determine in what the user was interested. The tool used to interact with the image may provide the intent of the user, such as whether the user intends for a feature to be included in other objects (in a subsequent search) or excluded. For example, erasing a pocket from a search is indicative that the user likes the shirt shown in the image but without a pocket and the subsequent search may filter to remove shirts with a pocket or to promote results that show shirts without a pocket.

At block 254, an input with the one or more features of interest is determined. The input may specify the feature(s) of interest or provide information that can be used to determine a feature of interest to be used in boosting a subsequent an image search (e.g., to generate prompts for a LLM 230, generate a new keyword string, adjust weights for filtering or reordering search results, etc.). It can be appreciated that blocks 250, 252, and 254 may be performed at the same time or using a different number of operations than what is shown in FIG. 5 depending on the nature of the interactions and how the features of interest are detected, provided/input, etc.

At block 256, the input, which may include one or more features of interest and other metadata 234 such as intent inferred from the nature of the interactions, is used in an image search by modifying a search metric to bias the image search towards locating other images (i.e., one or more second images as specified in FIG. 5) based on the features of interest. For example, a subsequent search based on editing a first image to change a V-neck to a crew neck may boost search results or target possible search results wherein the t-shirt is found to also include a crew neck. The boosted search metrics 236 may be generated by the search modifier engine 222 as illustrated in FIG. 3b and those search metrics 236 provided to the search boost feature 206 to bias the search function 210 in performing its subsequent search. As such, the operations shown in FIG. 5 may be performed by the search function 210 (utilizing the search boost 206) along with the boosted search module 300. While the boosted search module 300 is illustrated as being a separate entity, as discussed above, the modules, features and engines shown in FIGS. 3a and 3b may be part of the same entity or the same overarching product, platform, service, software program, or the like.

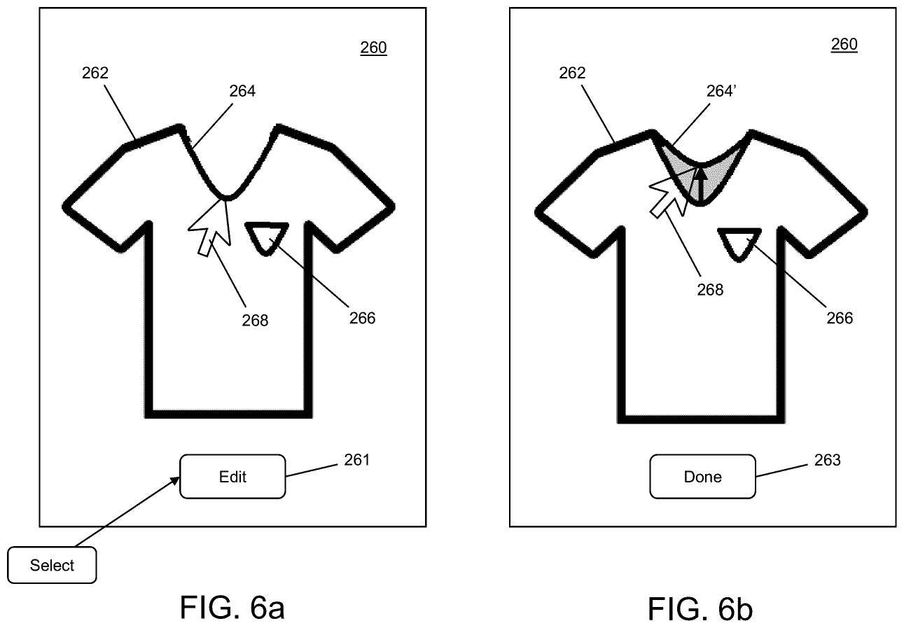

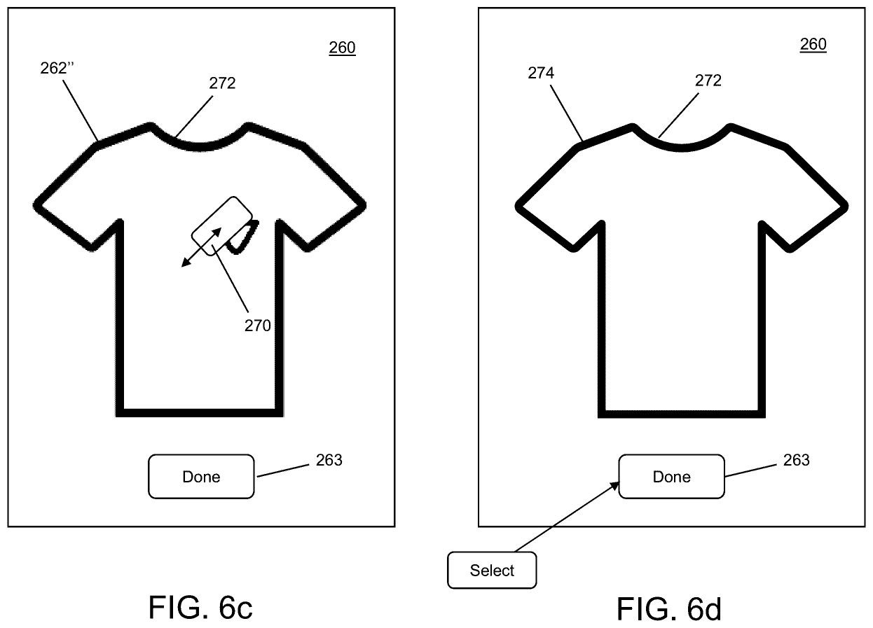

Referring now to FIGS. 6a-6d, an example image editing process is shown that may be used in determining features of interest to boost a subsequent search, e.g., according to the workflow shown in FIG. 3b and the operations shown in FIG. 5. In this example, an image 260 is presented to the user, and the application 202 or search function 210 enables the user to interact with this image 260. For example, the image 260 may have been found in a product search conducted by the user via the search function 210. The user may be presented with an Edit option 261 that, when selected as shown in FIG. 6a, enables the user to edit the image 260. The image 260 includes a t-shirt 262 have a V-neck and breast pocket 266 among other features. The image editor 214 may be called or otherwise accessed in this example to input the image 260 into an editing UI or present editing tools with the image 260 as shown in FIG. 6a until a Done option 263 is selected (see FIG. 6d described below).

A cursor 268 is shown in this example, which can be used, as shown in FIG. 6b, to drag the V-neck 264 upwards (as illustrated using a grey fill) to create a crew neck 264′. Referring now to FIG. 6c, the user in this example additionally edits the image 260 by using an eraser tool 270 to remove the breast pocket 266, resulting in the modified t-shirt 274 shown in FIG. 6d, which includes a crew neck 272 and omits any breast pocket 266. The user may select the Done option 263 to complete the editing process. In this case, the interactions 218 involved a modification/change and a removal. This may result in the generation of metadata 234 indicating that the features of interest to be determined by the feature of interest extractor 220 include both features that the user desires as well as those they wish to omit. By identifying these features of interest, the search modifier engine 222 is able to modify or create new boosted search metrics 236 that bias a subsequent search towards crew neck shirts but away from those with breast pockets 266. As indicated above, the feature of interest extractor 220 may use any suitable and available tool to identify the features of interest, from direct indications from textual input, labels, etc.; to using before and after images and an LLM 230 to determine what has changed, among other things.

It can be appreciated that the interactions 218 and metadata used by the feature of interest extractor 220 to determine these features of interest may vary based on what information the image editor 214 and/or search boost feature 206 are capable of detecting. For example, the image edits may track interactions with certain pixels or may be able to correlate pixel locations to tags or labels in the image 260 that are used to identify the features. Other image processing such as SIFT 232 or the use of an LLM 230 which has been prompted to find differences between the image 260 as seen in FIG. 6a and the image 260 as seen in FIG. 6d may also be used. Any combination of interactions 218 and metadata 234 may therefore be generated and used as inputs to determine features of interest that boost a subsequent search. The search modifier engine 222 can likewise be operable to utilize various inputs to generate a new set of boosted search metrics 236 or to modify same. For instance, as discussed above, additional keywords can be added, weights can be applied to certain features to assist in filtering or reordering search results, among other things.

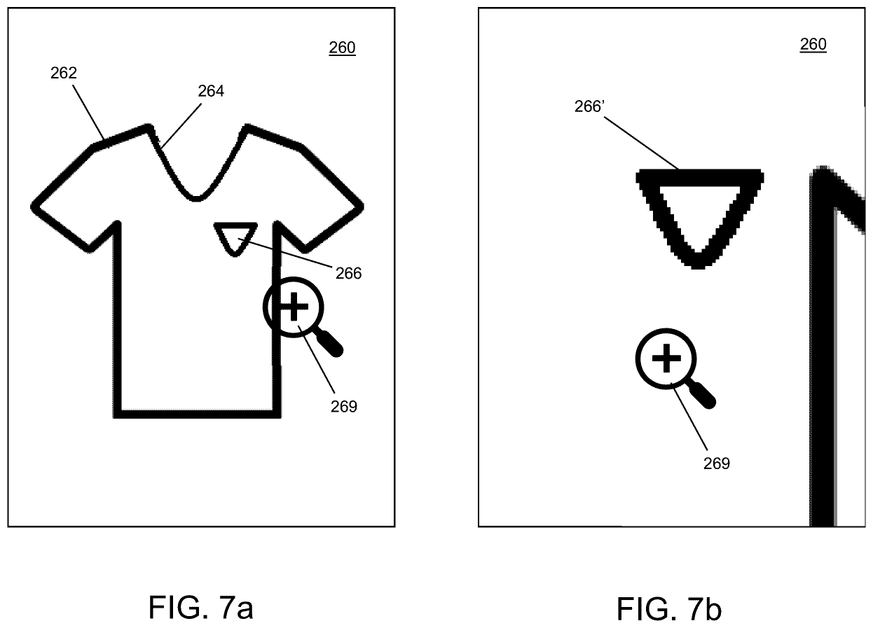

FIGS. 7a and 7b illustrate another image interaction, namely a zoom operation. Referring first to FIG. 7a, the image 260 from FIG. 6 is shown, with a t-shirt 262 having a V-neck 264 and breast pocket 266. In this example, the user is provided with a zoom tool 269, e.g., via the search function 210, image editor 214, application 202, or search boost feature 206. By zooming in on the breast pocket 266 to generate an enlarged view 266′ of the breast pocket 266, metadata 234 may be generated that is indicative of an interest in the breast pocket 266. Depending on any adjacent edits, such as an erasure of the breast pocket 266, a recoloring, etc., the feature of interest extractor 220 may identify the breast pocket 266 as either a feature of interest for inclusion or a feature of interest for exclusion, which may inform the search modifier engine 222 as discussed above. Therefore, as illustrated in FIGS. 7a and 7b, the interactions 218 may include both passive and active operations wherein edits may include both changes to features as well as (or alternatively) the identification of areas or regions of interest. Such operations may provide inputs to image processing techniques that are operable to detect areas or regions of interest which may include content that may be correlated or mapped to features of interest that lie within such areas or regions.

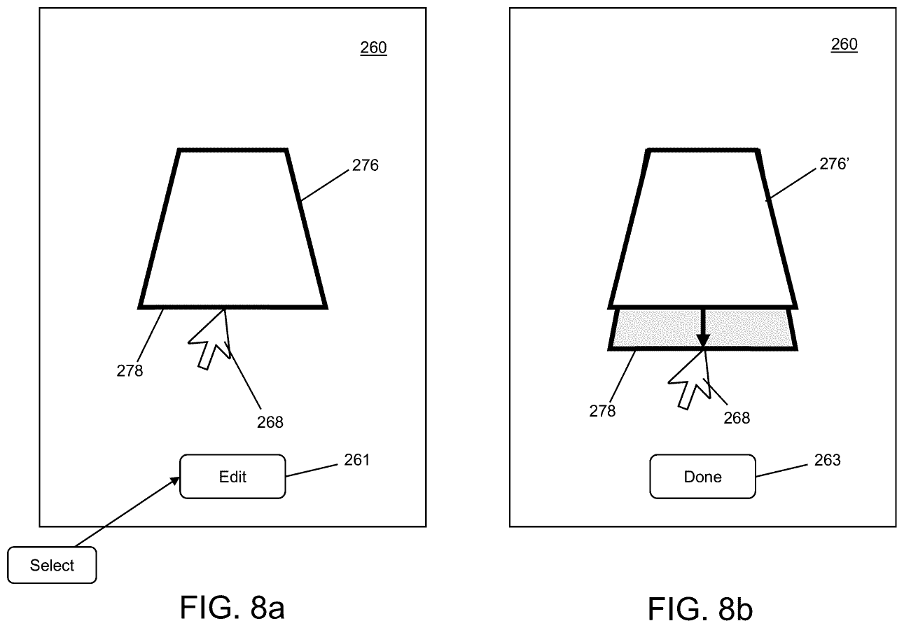

FIGS. 8a and 8b illustrate yet another image interaction, namely an enlarging of a feature that may create a new category of product. In this example, a skirt 276 is shown in FIG. 8a. By selecting the Edit option 261, the user may initiate the cursor 268 to allow them to drag the hem of the skirt, illustrated using the grey fill in FIG. 8b. In this example, by lengthening the hem 278 as shown, the skirt 276 may be altered in such a way that it should be recategorized as a dress 276′, namely due to its length. A similar operation that lengthens the sleeves of the t-shirt 262 from FIGS. 6 and 7 is another example of an alteration that could recategorize an item. In such a scenario, the metadata 234 may indicate that features of the skirt 276 are of interest to the user, but in a “dress” category of garment. Accordingly, image edits and/or other interactions may not only modify a certain product or object but also may recategorize the object as a result of the interaction 218.

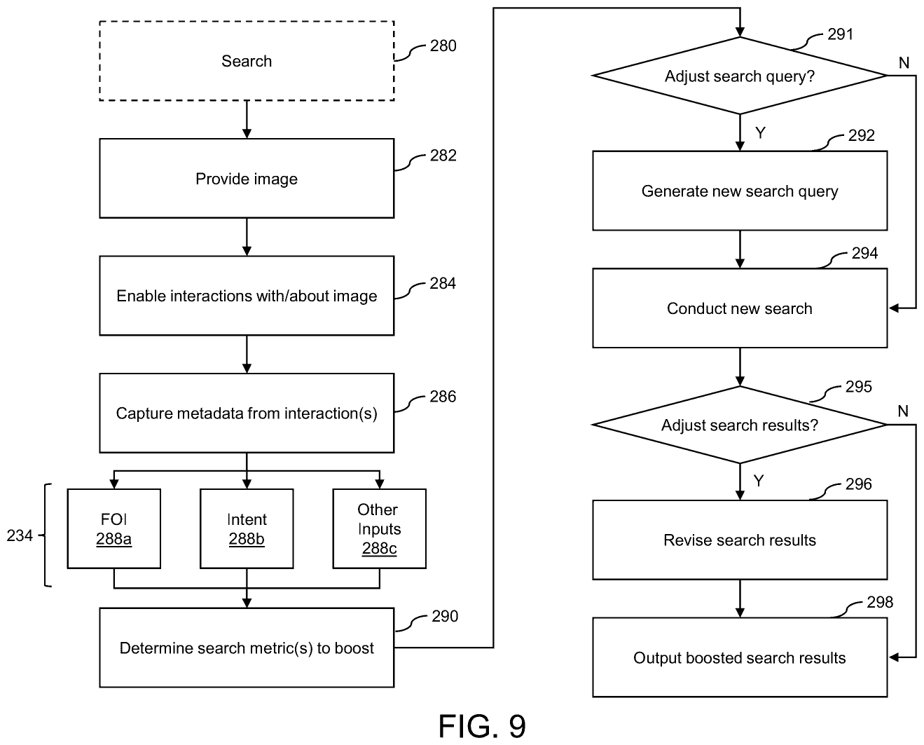

Referring now to FIG. 9, a flow chart is provided illustrating example operations for adjusting a subsequent search based on interactions with an image from a previous search. At block 280, a search has been conducted. Block 280 is shown in dashed lines to illustrate that the image provided at block 282 may originate from such a search, but may come from some other origin, such as the selection of an image included in a product catalogue or displayed on a website without necessarily conducting a search.

At block 284, the image provided at block 282 may be interacted with by the user. The search function 210 (or application 202 more generally) may provide access to image editing or other manipulation or interactivity tools, e.g., as illustrated in FIGS. 6, 7, and 8 described above. By enabling interactions with the image 260 at block 284, metadata 234 generated during those interactions may be captured at block 286. The metadata 234 may include or provide various forms of data and information, for example, features of interest (FOI) 288a, intent 288b (e.g., include/exclude, like/dislike, etc.), and other inputs 288c such as gaze, touch, text inputs, etc. The metadata types 288 may be used at block 290 to determine one or more search metrics to boost, e.g., by generating or modifying one or more boosted search metrics 236 as shown in FIG. 3b.

At block 291, the search modifier engine 222 (and/or the search function 202 in cooperation with the search modifier engine 222) determines whether to adjust a search query in order to target the features of interest. If so, a new search query may be generated at block 292, e.g., by adding or refining a set of keywords or applying weights to bias certain keywords more prominently in generating search results. A new search may then be conducted at block 294, whether the search query is adjusted or not.

At block 295, the search modifier engine 222 (and/or the search function 202 in cooperation with the search modifier engine 222) determines whether to adjust the search results based on the interactions 218. For example, the interactions may suggest that crew neck t-shirts are of higher interest to the user and any search results may be filtered or reordered or otherwise revised accordingly at block 296. The boosted search results may then be output at block 298, e.g., by returning a set of images that is generated based on the boosted search.

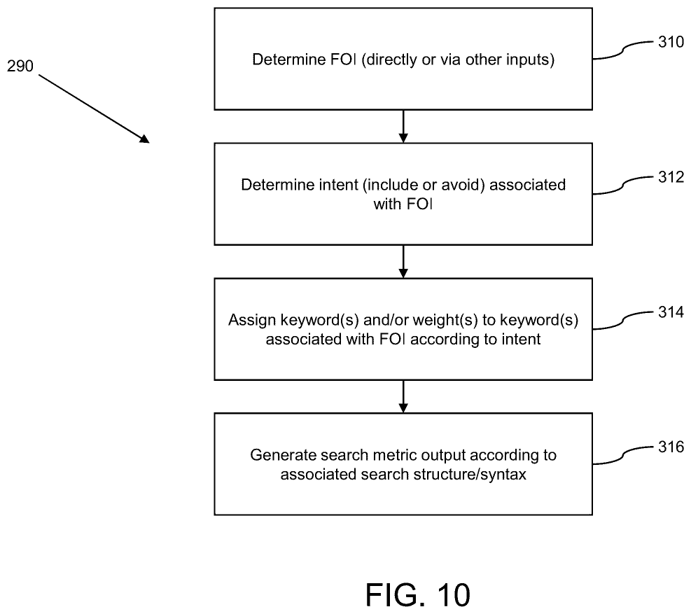

Referring now to FIG. 10, a flow chart is provided illustrating example operations for determining search metrics to boost the subsequent search, e.g., at block 290 in FIG. 9. At block 310, the search modifier engine 222 determines one or more features of interest (FOI), which may be done via or in cooperation with the feature of interest extractor 220 or directly via the metadata 234.

At block 312, the search modifier engine 222 may also determine any intent associated with the FOIs, e.g., whether a feature of interest is meant to be included (boosted up) or excluded (boosted down) in order to include or avoid such a feature in the subsequent search results. At block 314, the FOI(s) and intent may be used to assign keywords and/or weights to keywords to be used in the subsequent search, which may depend on the syntax or format of the search being conducted. This enables the search modifier engine 222 to generate a search metric output (e.g., one or more boosted search metrics 236) at block 316, which adhere or conform to the structure of syntax of the search being conducted by the search function 202. That is, the search modifier engine 222 may cooperate with the search function 202 and search boost feature 206 to not only determine what to boost in the subsequent search but also how to boost that particular search using that particular search function 210.

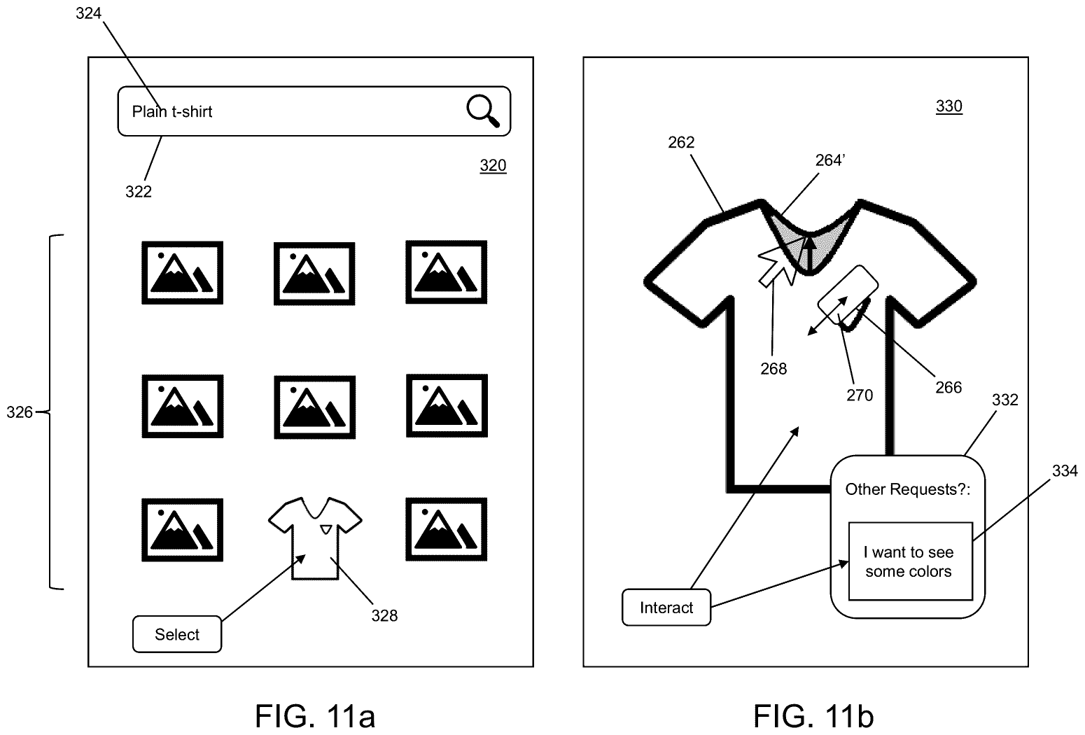

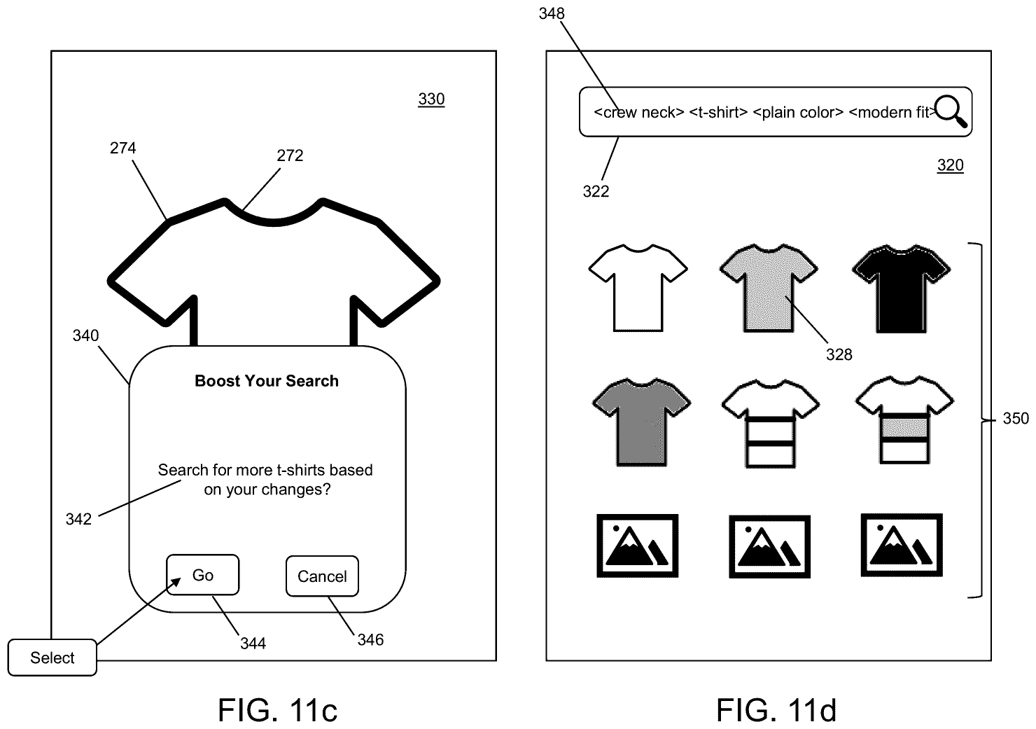

Referring now to FIG. 11a, an application UI 320 is shown, e.g., for application 202 that includes a search bar 322 for implementing the search function 210. In this example, the UI 320 enables a user 208 to search for products, e.g., in a product catalogue or e-commerce site. The search function 210 is utilized by entering text into the search bar 322 and returns, in this example, a set 326 of images 328 for the search result. For example, the UI 320 illustrated in FIG. 11a may display images 328 of a number of plain t-shirts. One of the images 328 is selected as shown in FIG. 11a, which launches an image editor UI 330 as shown in FIG. 11b.

As shown in FIG. 11b, the image editor UI 330 enables a user to interact with the t-shirt 262 shown in the image 328 that was selected. The interactions shown in FIG. 11b are the same as those illustrated in FIGS. 6a-6d described above, namely edits applied to create a crew neck version of the t-shirt 262 without a breast pocket 266. FIG. 11b additionally illustrates the provision of a prompt 332 which asks the user if they have any other requests to edit the image 328 that was selected. In this example, the user has typed: “I want to see some colors”, which may be used to augment the metadata 234 to boost the subsequent search to include t-shirts with colors, in addition to the other edits.

Referring to FIG. 11c, the image editor UI 330 may also further display a boost prompt 340 asking the user whether they wish to perform a subsequent search based on the changes made, by providing a query 342 in the prompt 340. The user may select from a Go option 344 or a Cancel option 346. By selecting the Go option 334 as shown in FIG. 11c, a subsequent search may be conducted as shown in FIG. 11d.

Referring now to FIG. 11d, the application UI 320 is launched again, with the search bar 322 populated with a more detailed or “boosted” search query in this example. The set 350 of images 328 returned in the subsequent search includes, for example, various crew neck t-shirts without breast pockets and having various colors according to the interactions and other metadata 234 as illustrated in, for example, FIG. 11b.

The system and method described herein may therefore determine an input used to boost a search based on features of interest identified through interactions 218 by the user, with an image 328, which are detected by a boosted search module 300. Various types of interactions with the image 328 are possible and various feature extraction techniques may be used to generate the input as discussed above.

### An Example e-Commerce Platform

Although integration with a commerce platform is not required, in some embodiments, the methods disclosed herein may be performed on or in association with a commerce platform such as an e-commerce platform. Therefore, an example of a commerce platform will be described.

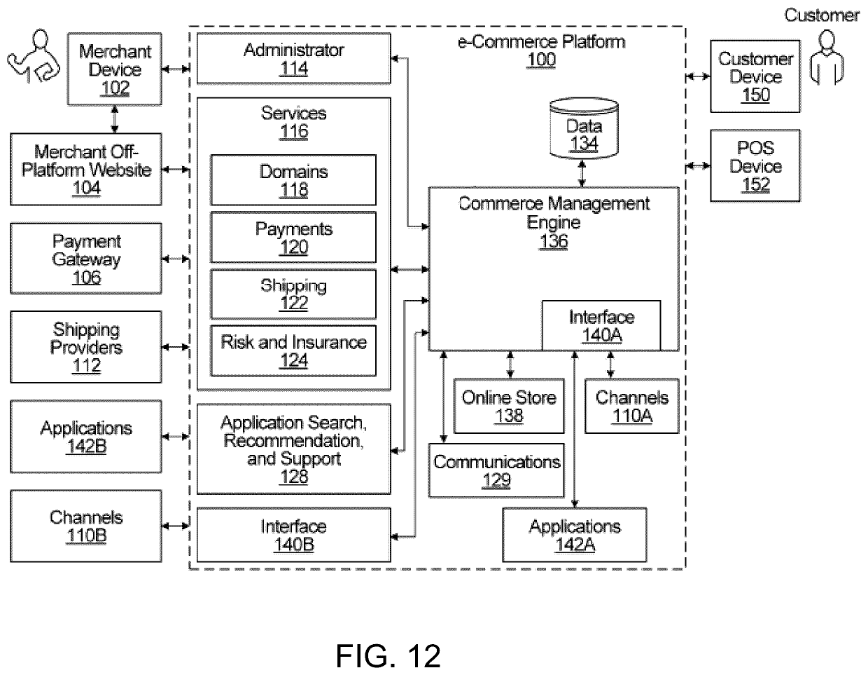

FIG. 12 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 12, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc., In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

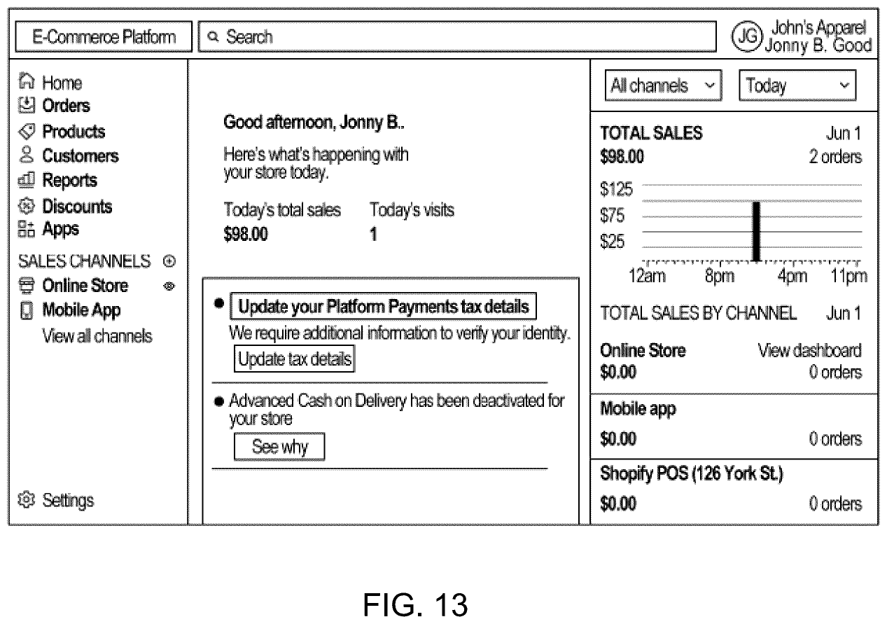

FIG. 13 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 13. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 12, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to obtain or capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date based ledger that records sale-related events that happened to an item).

### Implementation in an e-Commerce Platform

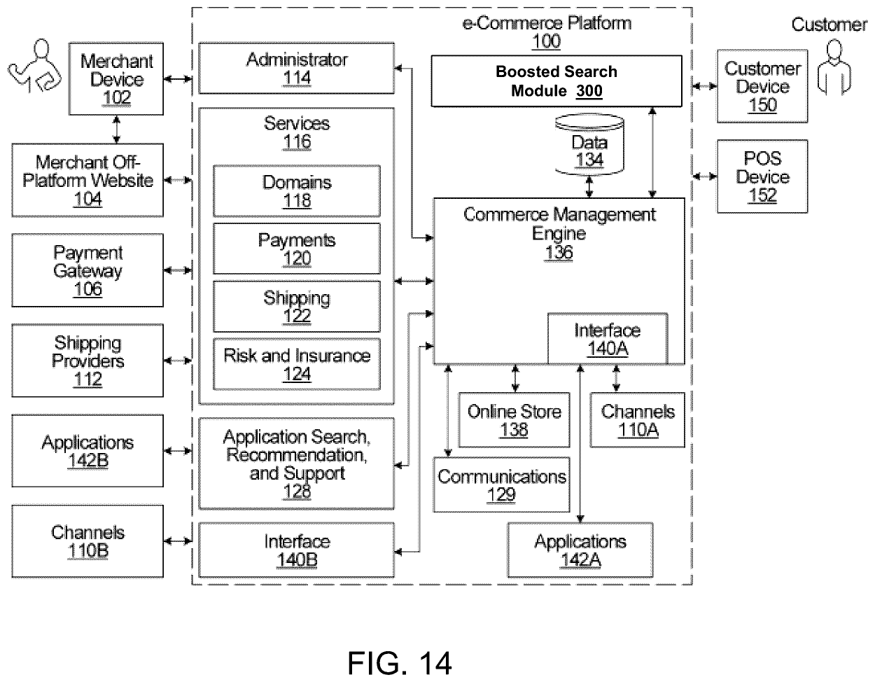

The functionality described herein may be used in commerce to provide improved customer or buyer experiences. The e-commerce platform 100 could implement the functionality for any of a variety of different applications, examples of which are described elsewhere herein. FIG. 14 illustrates the e-commerce platform 100 of FIG. 12 but including the boosted search module 300. The module 300 is an example of a computer-implemented system that implements the functionality described herein for use by the e-commerce platform 100, the customer device 150 and/or the merchant device 102.

Although the module 300 is illustrated as a distinct component of the e-commerce platform 100 in FIG. 14, this is only an example. An engine could also or instead be provided by another component residing within or external to the e-commerce platform 100. In some embodiments, either or both of the applications 142A-B provide an engine that implements the functionality described herein to make it available to customers and/or to merchants. Furthermore, in some embodiments, the commerce management engine 136 provides that engine. However, the location of the module 300 is implementation specific. In some implementations, the module 300 is provided at least in part by an e-commerce platform, either as a core function of the e-commerce platform or as an application or service supported by or communicating with the e-commerce platform. Alternatively, the module 300 may be implemented as a stand-alone service to clients such as a customer device 150 or a merchant device 102. In addition, at least a portion of such an engine could be implemented in the merchant device 102 and/or in the customer device 150. For example, the customer device 150 could store and run an engine locally as a software application. The e-commerce platform 100 can therefore be considered an example of a computing environment 10 in which the service provider application 28 and administrator UI controller 12 are implemented as a module 300, coupled to the commerce management engine 136 and/or interface 140B to enable the administrator UI functionality to be integrated into an administrator UI 70 displayed by the administrator UI controller 12 to the merchant device 102, the customer device 150, or both.

The module 300 could implement at least some of the functionality described herein, for example based on the examples shown in FIGS. 6a through 6d, 7a to 7b, 8a to 8b, or 11a through 11d. Although the embodiments described below may be implemented in association with an e-commerce platform, such as (but not limited to) the e-commerce platform 100, the embodiments described below are not limited to e-commerce platforms.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 200, computing device 240, computing system 400, e-commerce platform 100, or module 300, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method comprising:
responsive to detecting at least one interaction with a first image, determining at least one feature of interest associated with the interaction; and
using the feature of interest for an image search by modifying a search metric to bias the image search towards locating one or more second images based on the at least one feature of interest.

2. The method of claim 1, wherein the at least one feature of interest is determined from the at least one interaction with the first image by associating the at least one interaction with one or more portions of the first image.

3. The method of claim 2, wherein the at least one feature of interest is determined by applying a feature extraction technique to at least the one or more portions of the first image.

4. The method of claim 3, wherein the one or more portions of the first image comprise an edited portion of the first image.

5. The method of claim 4, further comprising:
providing an image editing tool;
obtaining the at least one interaction with the first image based on edits to the first image made using the editing tool;
associating the edits with the one or more portions of the first image; and
applying the feature extraction technique to identify the at least one feature of interest according to what was edited using the editing tool.

6. The method of claim 3, wherein the feature extraction technique applies a scale invariant feature transform (SIFT) algorithm.

7. The method of claim 1, wherein the search metric comprises a feature weight.

8. The method of claim 1, wherein the at least one feature of interest is determined by:
comparing an original first image to a modified first image to determine one or more changes; and
associating the one or more changes with the at least one feature of interest.

9. The method of claim 8, wherein the comparing is performed by prompting a large language model (LLM) to describe what has changed between the original first image and the modified first image.

10. The method of claim 9, wherein the one or more changes comprise an edited portion of the original first image.

11. The method of claim 10, further comprising:
providing an image editing tool;
obtaining the at least one interaction with the first image based on edits to the original first image made using the editing tool to generate the modified first image;
associating the edits with one or more portions of the original first image; and
applying the feature extraction technique to identify the at least one feature of interest according to what was edited using the editing tool.

12. The method of claim 1, further comprising training at least one model associated with one or more of: i) the at least one interaction, ii) associating the at least one interaction with one or more portions of the first image, or iii) the image search; based on an item category associated with the at least one feature of interest.

13. The method of claim 12, wherein the item category comprises a product category.

14. The method of claim 1, wherein the at least one interaction comprises selection of a feature, zooming of a feature, annotating a feature, or identifying a feature using text, voice or eye gaze.

15. The method of claim 1, wherein the first image is obtained from a first search and the image search corresponds to a subsequent search.

16. A system comprising:
at least one processor; and
at least one memory, the at least one memory comprising processor executable instructions that, when executed by the at least one processor, cause the system to:
responsive to detecting at least one interaction with a first image, determine at least one feature of interest associated with the interaction; and
use the feature of interest for an image search by modifying a search metric to bias the image search towards locating one or more second images based on the at least one feature of interest.

17. The system of claim 16, wherein the at least one feature of interest is determined from the at least one interaction with the first image by associating the at least one interaction with one or more portions of the first image.

18. The system of claim 17, wherein the at least one feature of interest is determined by applying a feature extraction technique to at least the one or more portions of the first image.

19. The system of claim 16, wherein the at least one feature of interest is determined by:
comparing an original first image to a modified first image to determine one or more changes; and
associating the one or more changes with the at least one feature of interest.

20. A non-transitory computer-readable medium comprising processor executable instructions that, when executed by a processor, cause the processor to:
responsive to detecting at least one interaction with a first image, determine at least one feature of interest associated with the interaction; and
use the feature of interest for an image search by modifying a search metric to bias the image search towards locating one or more second images based on the at least one feature of interest.
